(19) United States
(12) Patent Application Publication
(10) Pub. No.: US 2011/0003122 A1
(43) Pub. Date: Jan. 6, 2011

(54) PHOTOVOLTAIC MODULE

(76) Inventors: Oliver HOCHREIN, Mainz (DE); Axel Engel, Ingelheim (DE); Jochen Alkemper, Klein-Winternheim (DE)

Correspondence Address: HARNESS, DICKEY & PIERCE, P.L.C., P.O. BOX 828, BLOOMFIELD HILLS, MI, 48303, US

(21) Appl. No.: 12/828,784

(22) Filed: Jul. 1, 2010

(30) Foreign Application Priority Data
Jul. 2, 2009 (DE) 10 2009 031 972.7

(51) Int. Cl. B32B 1/00; C03C 3/112; C03C 3/118

(52) U.S. Cl. 428/174; 501/11; 501/57; 501/59

(57) ABSTRACT

A photovoltaic module having a fluoride-containing covering, substrate or superstrate glass is disclosed. The weight ratio X of the iron content to the fluorine content is preferably from 0.001 to 0.6. The glass to which fluoride has been added can be any glass suitable for photovoltaic modules, for example a soda-lime glass, a borosilicate glass or an aluminosilicate glass.

### CROSS-REFERENCE TO OTHER APPLICATIONS

The present application claims priority to German National Application No. 10 2009 031 972.7, filed Jul. 2, 2009, the entire contents of which are incorporated herein by reference.

### BACKGROUND OF THE INVENTION

The invention relates to a photovoltaic module having a covering, substrate or superstrate glass and an advantageous use of a particular glass in a photovoltaic module as a covering, substrate or superstrate glass.

In photovoltaics or in solar cells, covering, substrate and superstrate glasses are used. Covering glasses have the task of protecting the sensitive active components of the solar cell from external environmental influences (e.g. wind, rain, snow, hail, dirt, etc.). Substrate glasses serve for the deposition of thin layers of photoactive material. Superstrate glasses perform the task of a substrate glass and covering glass in one. The requirement profiles which the glasses have to meet depend on the respective module concept. They thus depend on the semiconductor materials used, on the function as substrate, covering or superstrate glass, etc. The covering and substrate glasses have to display a high total transmission in the respective relevant range. Here, reflection losses on the surfaces and absorption of the radiation in the glass are to be avoided if possible.

The transparency of the glasses is matched to the respective semiconductors. Thus, for example, modules which are based on crystalline silicon (single crystal or polycrystalline) have their maximum sensitivity in the wavelength range from about 400 to 1200 nm. For this reason, the transmission in this range should be optimized. Furthermore, a sufficient chemical resistance has to be ensured since the glasses are exposed to continually changing environmental stresses. Depending on the place at which the solar modules are erected, the environmental stresses can be very different. The glass used therefore has to have a good resistance to water, acids and alkalis. Changing temperature conditions or frost also pose particular demands. For this reason, solar modules are, for example, subjected to simulated changes in climatic conditions (cf. the “damp heat test”).

Substrate and superstrate glasses additionally have to withstand thermal and chemical stresses in the deposition of the coating material. They have to withstand, for example, the deposition of an electrically conductive, transparent layer and the photoactive material deposited thereon. This means sufficient heat resistance and resistance to vacuum processes.

In the prior art, the use of soda-lime glasses is widespread because of their particularly inexpensive production. However, these have some critical disadvantages when used for the production of photovoltaic modules or solar cells:
the index of refraction of soda-lime glasses is relatively high with an n_{d} of about 1.52. This leads to large losses of useful radiation by reflection at the surfaces, in particular at the glass-air interface;
impurities in the glasses lead to absorption of useful radiation by the glass. The iron content and the charge on the iron ions are of particular importance here. While Fe³⁺ displays a relatively weak and narrow absorption at about 380 nm in the glass, the Fe²⁺ ions which are likewise present in all solar glasses used at present lead to a broad and strong absorption in the red to infrared wavelength range. These absorption bands thus lead to a significant loss of useful radiation of the solar spectrum. For this reason, particularly pure and thus expensive, low-iron raw materials are used for use as solar glasses.
soda-lime glasses have a transmission loss on irradiation with sunlight (solarization). The polyvalent ions such as cerium which are added to the glasses are particularly prone to produce solarization.

According to EP 1 281 687 A1, a particularly pure glass which has a low iron oxide content and is additionally provided with from 0.025 to 0.2% by weight of cerium oxide is used to achieve a high transmission. A particular ratio of FeO to Fe₂O₃ and a particular addition of cerium oxide are important here.

However, adherence to a particular Fe²⁺/Fe³⁺ ratio is a relatively difficult and expensive undertaking. In addition, particular cerium-containing glasses have a strong tendency to solarization. In extreme cases, yellowish to brownish discoloration after intensive irradiation is observed here.

According to EP 1 291 330 A2, a soda-lime glass which likewise has a low iron oxide content of less than 0.020% of Fe₂O₃ and an addition of from 0.006 to 2% by weight of zinc oxide is used for solar cells. The zinc oxide is added to counter the formation of nickel sulphide (NiS). Optimum transparency requires a particular ratio of iron oxide to zinc oxide and also cerium oxide.

This again requires the use of particularly expensive raw materials. The relatively high content of cerium oxide can also have adverse effects.

In particular, a high content of cerium oxide, for instance as per EP 0 261 885 A1, has been found to be disadvantageous in respect of solarization on strong irradiation. Such glasses having a cerium oxide content of at least 2% by weight are therefore not considered to be suitable for solar cell applications or photovoltaic applications.

The use of an antimony-doped soda-lime glass which is particularly low in iron is proposed in US 2007/0144576 A1. Particularly in combination with cerium doping, disadvantages due to solarization on strong irradiation can show up here.

### SUMMARY OF THE INVENTION

In view of this it is a first object of the invention to disclose an improved glass for use as a covering, substrate or superstrate glass in a photovoltaic module.

It is a second object of the invention to disclose an improved glass for use as a covering, substrate or superstrate glass in a photovoltaic module that has a high transmission even in a solarized state.

It is a third object of the invention and to disclose an improved photovoltaic module comprising such a glass.

According to the invention these and other objects are achieved in a photovoltaic module having a fluoride-containing covering, substrate or superstrate glass by adding a particular minimum content of fluorine as a function of the iron content of the glass. Here, the weight ratio of the iron content to the fluorine content X=Fe/F is at least 0.001, preferably at least 0.002, more preferably at least 0.005, particularly preferably at least 0.01.

The object of the invention is completely achieved in this way.

It has surprisingly been found that an addition of fluoride leads, independently of the base glass composition, to an improvement in transmission; in particular, the disadvantages of iron oxide present in the glass can be reduced or compensated. The transmission of a fluorine-containing glass in the unsolarized state and in the solarized state is above that of a conventional, fluorine-free glass which otherwise has the same composition. A measured addition of fluorine ions obviously results in an interaction with iron oxide, which enables the disadvantageous influences of iron oxide on the transmission behaviour to be eliminated or compensated.

In an advantageous embodiment of the invention, the weight ratio X is preferably not more than 0.6, more preferably not more than 0.4, more preferably not more than 0.2, particularly preferably not more than 0.1.

Particularly in a precise metered addition of fluoride as a function of the iron content, the glass properties can be increased overproportionally without the disadvantages of a fluoride addition, e.g. increased costs and reduction in tank operating lives by increased corrosive attack, becoming significant. Essentially, an optimum ratio of the fluoride content to the content of iron impurities can be set. If the ratio is below this optimum, only very small positive transmission effects can be achieved. If the ratio is above this optimum, no further increase in the transmission can be observed and the abovementioned negative effects dominate.

Covering, substrate or superstrate glasses according to the invention preferably have a weight ratio X of from 0.02 to 0.6. In this range in particular, the transmission is increased compared to glasses having an otherwise identical composition, both in the unsolarized state and in the solarized state.

In addition to the abovementioned specific reduction in the negative effect of iron impurities, the addition of fluoride results in further advantages:
Fluoride reduces the index of refraction of the glass. This reduces the reflection losses at the surfaces. Thus, a larger proportion of useful radiation reaches the solar cell. In the examples in Table 1, this effect contributes about one third to the total transmission increase observed.
Furthermore, it has been found that the fusibility is improved by addition of fluoride compared to a conventional soda-lime glass. Fluoride acts as a melting aid here. In this way, the melting temperatures and thus the energy costs can be reduced.
Finally, the glass is stabilized by the addition of fluoride. The surprisingly high resistance to environmental influences (attack by water, acids, alkalis) which is observed can be attributed thereto. In addition, the glass/polymer film interface is apparently positively influenced.

The use according to the invention of fluoride-containing glasses in solar cells or photovoltaic modules can firstly be employed to maximize the efficiency. Secondly, it is possible to reduce the raw materials costs by using comparatively cheap, conventional raw materials having a moderate iron content. A certain iron content is often advantageous for the glass melt. The use of fluoride thus allows more favourable production costs and good transmission properties of the glasses to be optimized. In parallel to the cost saving, the reduction in the melting temperature due to the addition of fluoride leads, due to the lower energy consumption, to an improvement in the ecological balance.

In a first embodiment of the invention, the glass is a soda-lime glass to which fluoride has been added.

This can contain, for example, from 40 to 80% by weight of SiO₂, from 0 to 50% by weight of Al₂O₃, from 3 to 30% by weight of R₂O, from 3 to 30% by weight of R′0 and also further constituents in an amount of from 0 to 10% by weight, where R is at least one element selected from the group consisting of Li, Na and K and R′ is at least one element selected from the group consisting of Mg, Ca, Sr, Ba and Zn.

Further preference is given to using soda-lime glasses which contain from 50 to 76% by weight of SiO₂, from 0 to 5% by weight of Al₂O₃, from 6 to 25% by weight of R₂O, from 6 to 25% by weight of R′O and further constituents in an amount of from 0 to 10% by weight and are additionally admixed with fluoride.

Preference is here given to adding at least 0.1% by weight, preferably at least 0.5% by weight, of Al₂O₃, mainly to improve the chemical resistance of the glass and its resistance to devitrification.

Furthermore, the fluoride-containing glass can be, for example, a borosilicate glass to which fluoride has been added.

This can contain, for example, from 60 to 85% by weight of SiO₂, from 1 to 10% by weight of Al₂O₃, from 5 to 20% by weight of B₂O₃, from 2 to 10% by weight of R₂O, and from 0 to 10% by weight of further constituents, where R is at least one element selected from the group consisting of Li, Na and K.

In particular, this can be a glass which contains from 70 to 83% by weight of SiO₂, from 1 to 8% by weight of Al₂O₃, from 6 to 15% by weight of B₂O₃, from 3 to 9% by weight of R₂O, and from 0 to 10% by weight of further constituents and has additionally been admixed with fluoride.

Furthermore, the glass according to the invention can be, for example, a fluoride-containing aluminosilicate glass.

This can typically contain from 55 to 70% by weight of SiO₂, from 10 to 25% by weight of Al₂O₃, from 0 to 5% by weight of B₂O₃, from 0 to 2% by weight of R₂O, from 3 to 25% by weight of R′O and further constituents in an amount of from 0 to 10% by weight, where R is once again at least one element selected from the group consisting of Li, Na and K and R′ is at least one element selected from the group consisting of Mg, Ca, Sr, Ba and Zn.

Here, the addition of B₂O₃ can preferably be at least 0.5% by weight. This achieves a further improvement in, in particular, the chemical resistance and resistance to environmental influences.

In the glass according to the invention, the iron oxide content can preferably be in the range from 0.005 to 0.25% by weight.

In this range, the adverse effects of the iron oxide content can be largely compensated by an appropriate fluorine addition.

Furthermore, the glass according to the invention can preferably have a cerium oxide content of at least 0.001% by weight, which is preferably limited to not more than 0.25% by weight. In this way, the UV stability of the glass according to the invention can be improved without excessive solarization occurring.

It goes without saying that the glass according to the invention has a suitable shape depending on the construction of the photovoltaic module. It can thus be, for example, a planar glass or a cylindrical or spherically curved glass. Further shapes are conceivable.

### DETAILED DESCRIPTION OF THE PREFERRED EMBODIMENTS

### Examples

Table 1 shows two different glasses in the form of a soda-lime glass and a borosilicate glass as Comparative Example 1 and Comparative Example 2. These are glasses conventionally used for photovoltaic modules. In addition, an example according to the invention is given as Example 1 and Example 2 for the soda-lime glass and the borosilicate glass, respectively. In Example 1, 0.3 g of fluorine has been added to the other constituents, while in Example 2, 0.5 g of fluorine has been added to the other constituents. It should be noted that the figures in the table are not in percent by weight but are absolute values; conversion into percent by weight would then lead to slightly altered values.

The ratio X, i.e. the ratio of iron to fluorine, is given in the last line. The transmission is also reported, showing that the transmission is in all cases increased by the addition of fluoride. If raw materials having a higher iron oxide content are used, an even more distinct improvement is achieved by the addition of fluoride compared to glasses without addition of fluoride.

TABLE 1

| | Soda-lime glass | | Borosilicate glass | |
|---|---|---|---|---|
| Glass constituents | Comparative | | Comparative | |
| (weight in g) | Example 1 | Example 1 | Example 2 | Example 2 |
| SiO₂ | 71 | 71 | 81 | 81 |
| Al₂O₃ | 1 | 1 | 2 | 2 |
| B₂O₃ | | | 13 | 13 |
| Li₂O | | | | |
| Na₂O | 14 | 14 | 3 | 3 |
| K₂O | | | 1 | 1 |
| MgO | 4 | 4 | | |
| CaO | 10 | 10 | | |
| Fe₂O₃ | 0.012 | 0.012 | 0.008 | 0.008 |
| CeO₂ | 0.005 | 0.005 | 0.1 | 0.1 |
| F | | 0.3 | | 0.5 |
| Refining agents | 0.5 | 0.5 | 0.5 | 0.5 |
| Total | 100.517 | 100.817 | 100.608 | 101.108 |
| Transmission [%] T(400- | 91.22 | 91.52 | 92.96 | 93.05 |
| 1200) not solarized | | | | |
| Transmission [%] T(400- | 90.54 | 90.95 | 92.32 | 92.53 |
| 1200) solarized | | | | |
| $X = \frac{Fe}{F}$ | — | 0.028 | — | 0.011 |

### BRIEF DESCRIPTION OF THE DRAWINGS

In the drawings:

FIG. 1 shows the transmission over the wavelength for Example 1 and for Comparative Example 1, in the unsolarized state and in the solarized state; and

FIG. 2 shows the transmission over the wavelength for Example 2 and for Comparative Example 2, in the unsolarized state and in the solarized state.

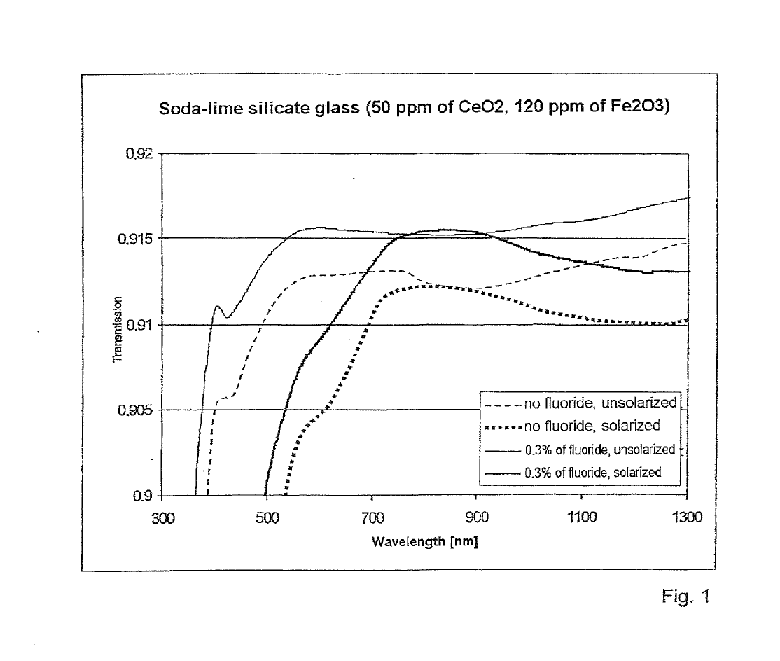

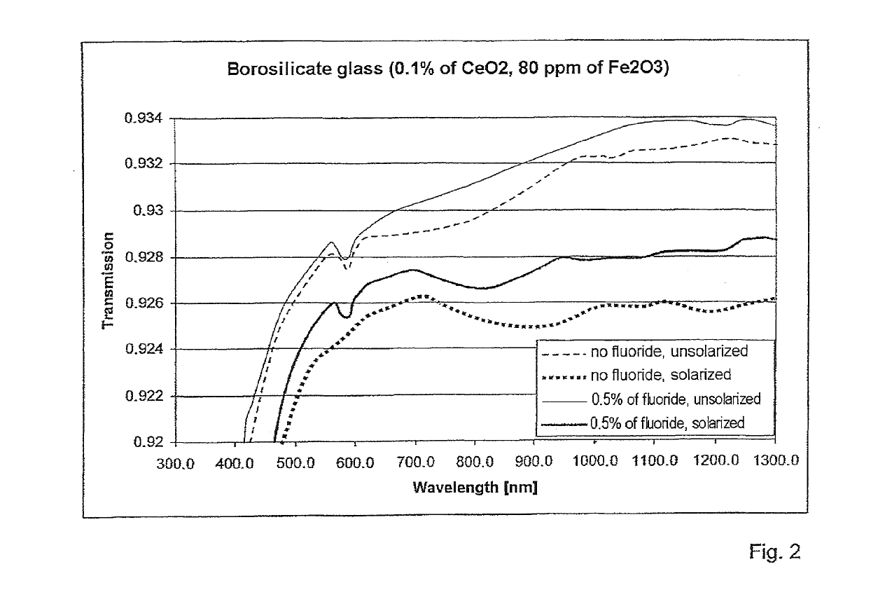

The effect of the fluoride addition on the transmission can be seen even more clearly from FIGS. 1 and 2 below, which show the transmission for Comparative Example 1 and Example 1 and for Comparative Example 2 and Example 2, in each case in the unsolarized state and in the solarized state. Particularly in the wavelength range 400-1300 nm, a significantly improved transmission can be observed.

What is claimed is:

1. An element in a photovoltaic module, said element selected from the group formed by a covering, a substrate and a superstrate, said element comprising a glass having a certain iron content and a certain fluorine content;
wherein a weight ratio defined by said iron content divided by said fluorine content X=Fe/F is at least 0.001.

2. The element of claim 1, wherein said weight ratio is not more than 0.6.

3. The element of claim 1, wherein said glass is a soda-lime glass comprising fluorine.

4. The element of claim 3, wherein said glass contains 40-80% by weight of SiO₂, 0-5% by weight of Al₂O₃, 3-30% by weight of R₂O, 3-30% by weight of R′O and further constituents in an amount of 0-10% by weight, where R is at least one element selected from the group consisting of Li, Na and K and R′ is at least one element selected from the group consisting of Mg, Ca, Sr, Ba and Zn.

5. The element of claim 3, wherein said glass contains 50-76% by weight of SiO₂, 0-5% by weight of Al₂O₃, 6-25% by weight of R₂O, 6-25% by weight of R′O and further constituents in an amount of 0-10% by weight, where R is at least one element selected from the group consisting of Li, Na and K and R′ is at least one element selected from the group consisting of Mg, Ca, Sr, Ba and Zn.

6. The element of claim 3, wherein said glass contains at least 0.1% by weight of Al₂O₃.

7. The element of claim 1, wherein said glass is a borosilicate glass comprising fluorine.

8. The element of claim 7, wherein said glass contains 60-85% by weight of SiO₂, 1-10% by weight of Al₂O₃, 5-20% by weight of B₂O₃, 2-10% by weight of R₂O and 0-10% by weight of further constituents, where R is at least one element selected from the group consisting of Li, Na and K.

9. The element of claim 8, wherein said glass contains 70-83% by weight of SiO₂, 1-8% by weight of Al₂O₃, 6-14% by weight of B₂O₃, 3-9% by weight of R₂O and 0-10% by weight of further constituents, where R is at least one element selected from the group consisting of Li, Na and K.

10. The element of claim 1, wherein said glass is an aluminosilicate glass comprising fluorine.

11. The element of claim 10, wherein said glass comprises 55-70% by weight of SiO₂, 10-25% by weight of Al₂O₃, 0-5% by weight of B₂O₃, 0-2% by weight of R₂O, 3-25% by weight of R′O and further constituents in an amount of from 0-10% by weight, where R is at least one element selected from the group consisting of Li, Na and K and R′ is at least one element selected from the group consisting of Mg, Ca, Sr, Ba and Zn.

12. The element of claim 11, wherein said glass contains at least 0.5% by weight of B₂O₃.

13. The element according to claim 1, wherein said glass has an iron oxide content of 0.005 to 0.25% by weight.

14. The element according to claim 1, wherein said glass has a cerium oxide content of at least 0.001% by weight.

15. The element according to claim 1, wherein said glass has a cerium oxide content of not more than 0.25% by weight.

16. The element according to claim 1, wherein said glass has a shape which is selected from the group consisting of planar, cylindrical and spherically curved.

17. An element in a photovoltaic module, said element selected from the group formed by a covering, a substrate and a superstrate, said element comprising a glass having a certain iron content and a certain fluorine content;
wherein a weight ratio defined by said iron content divided by said fluorine content X=Fe/F is 0.01 to 0.1.

18. The element of claim 1, wherein said glass has an iron content of 0.005 to 0.25% by weight, and a cerium oxide content of 0.001% to 0.25% by weight.

19. The element according to claim 1, wherein said glass has an aluminum oxide content of at least 0.5% by weight.

20. A glass for use as a covering, a substrate or a superstrate, said glass having a certain iron content and a certain fluorine content;
wherein a weight ratio defined by said iron content to said fluorine content X=Fe/F is at least 0.001.
